(19) United States
(12) Patent Application Publication
(10) Pub. No.: US 2012/0105249 A1
(43) Pub. Date: May 3, 2012

(54) Method and Distributed System for Detecting and Managing Data from a Plurality of Measuring Devices

(75) Inventors: Wulfdieter Bauerfeld, Berlin (DE); Heiko-Armin Schoenebeck, Berlin (DE)

(73) Assignee: T-SYSTEMS INTERNATIONAL GMBH, FRANKFURT AM MAIN (DE)

(21) Appl. No.: 13/063,013

(22) PCT Filed: Sep. 7, 2009
(86) PCT No.: PCT/EP09/06475

§ 371 Date: May 31, 2011

(30) Foreign Application Priority Data
Sep. 9, 2008 (DE) 10 2008 046 450.3

(51) Int. Cl. G08C 15/00; G06F 15/16

(52) U.S. Cl. 340/870.02; 709/217

(57) ABSTRACT

A method for acquiring and managing data from a plurality of measuring instruments includes acquiring data from at least one measuring instrument disposed in each of at least one measurement station. The data is provided to a server computing unit. The data is processed in the server computing unit with at least one microserver so as to provide client-compatible data. The client-compatible data is accessed in the server computing unit of the at least one measurement station through a communication network in at least one client station. The accessed client-compatible data is further processed in the at least one client station with at least one client computing unit.

### CROSS REFERENCE TO PRIOR APPLICATIONS

This application is a U.S. National Phase application under 35 U.S.C. §371 of International Application No. PCT/EP2009/006475, filed on Sep. 7, 2009 and which claims benefit to German Patent Application No. 10 2008 046 450.3, filed on Sep. 9, 2008. The International Application was published in German on Mar. 18, 2010 as WO 2010/028788 A1 under PCT Article 21(2).

### FIELD

The present invention provides a method and a distributed system for managing data from a plurality of measuring instruments.

### BACKGROUND

DE 693 19 305 T2 describes a communications network with a master unit and multiple slave units, wherein the master unit is configured such that it transmits messages to the slave units and receives messages from them. The addition of newly installed slave units is described.

A system in which data from at least one measuring instrument are acquired, transmitted, and processed with multiple server programs is described in WO 03/027840 A1.

A system in which data are acquired from a plurality of measuring instruments and transmitted to a central station and processed there is described in WO 2008/094277 A1. The central station includes a user information system and a management module that controls the operating states of the measuring instruments. When the operating states of the measuring instruments are controlled by a management module, the number of measuring instruments that can be controlled simultaneously is limited.

### SUMMARY

An aspect of the present invention is to provide a method and a corresponding distributed system for acquiring and managing data from a plurality of measuring instruments in which the number of measuring instruments can be increased many times over without changing the system structure. A large number of measuring instruments (above approximately 10⁴) and frequent transmission of measurement data (for example, every 15 minutes) should thereby be possible.

In an embodiment, the present invention provides a method for acquiring and managing data from a plurality of measuring instruments which includes acquiring data from at least one measuring instrument disposed in each of at least one measurement station. The data is provided to a server computing unit. The data is processed in the server computing unit with at least one microserver so as to provide client-compatible data. The client-compatible data is accessed in the server computing unit of the at least one measurement station through a communication network in at least one client station. The accessed client-compatible data is further processed in the at least one client station with at least one client computing unit.

### BRIEF DESCRIPTION OF THE DRAWINGS

The present invention is described in greater detail below on the basis of embodiments and of the drawings in which:

FIG. 1 shows a block diagram of a distributed system according to the present invention;

FIG. 2 shows a sequence diagram for the principle of data exchange in a distributed system according to the present invention;

FIG. 3 schematically shows a distributed system according to the present invention with multiple measurement stations and one client station;

FIG. 3b shows a distributed system according to the present invention from FIG. 3a, in which the client station has a client computing unit, a data module (repository), and application modules;

FIG. 3c shows a distributed system according to the present invention from FIG. 3b with a client station with four application modules;

FIG. 4 shows a display of a format-interpreted XML document with status data of a measuring instrument;

FIG. 5 shows a display of a format-interpreted XML document with measurement data of a measuring instrument;

FIG. 6 shows a query and issuance of measurement data of an XML document at an end user;

FIG. 7 shows a 24-hour usage profile of an end user;

FIG. 8 shows a measurement station of a distributed system according to the present invention with several measuring instruments and a server computing unit having a primary microserver and additional microservers;

FIG. 9 shows the measurement station from FIG. 8 with the functions of the primary microserver;

FIG. 10 shows a microserver;

FIG. 11 shows a measurement station and a client station;

FIG. 12 shows an embodiment of the measurement station shown in FIG. 11, a client station, and an application module;

FIG. 13 shows an example of a sequence of a registration of a measuring instrument;

FIG. 14 shows an example of an acquisition of data from the measuring instrument;

FIG. 15 schematically shows a distributed system according to the present invention; and

FIG. 16 shows a detailed representation of a distributed system according to the present invention from FIG. 15.

### DETAILED DESCRIPTION

In an embodiment, the present invention provides a method for acquiring and managing data from a plurality of measuring instruments in which data in multiple measurement stations are acquired from at least one measuring instrument in each station. The data acquired from a measurement station are processed into client-compatible data and made available in a server computing unit. The data from the measurement stations that are made available are accessed over a communications network and further processed in at least one client station with at least one client computing unit.

A measuring instrument has one or more sensors for acquiring data. Examples include usage sensors for electricity, gas, and water. A measuring instrument is implemented as an electric meter, for example. The measuring instruments are designed as meters having at least one sensor and/or as instruments with additional applications, e.g. as household appliances, having at least one sensor and if applicable at least one actuator. A measuring instrument with additional applications for the domestic area is referred to as a household appliance. The measuring instruments, e.g. their operating states, are controlled by the server computing units.

In a measurement station, for example, in a household, a measuring instrument or multiple measuring instruments are located in spatial proximity. A measurement station comprises a domestic area, for example, of one or more households. Private households, workplaces, or public institutions are, for example, referred to as a domestic area.

A communications network is implemented as a wide-area network, to which participants can be connected even over long distances, and through which they can be connected to one another. A communications network is, for example, the Internet, i.e., the data are accessed with the aid of Internet protocols up to and including layer 7, specifically with the aid of standardized Internet protocols up to and including layer 7.

A server computing unit includes a processor and a server program that provides services that are always accessible in operation. A unit comprising a processor and server program is also called a server. The server used in the server computing unit is network-compatible, and when the Internet is used as the communications network it is in fact Internet-compatible. The server computing units manage the data acquired from the measuring instruments in that they process said data into client-compatible data and make it available, among other activities.

The client computing unit has a processor and a client program, wherein the client program is suitable for accessing the services of a server program. A unit comprising a processor and a client program is also called a client. Of necessity, the client of the client computing unit is likewise network-compatible, specifically Internet-compatible where applicable.

In an embodiment of the present invention, the client program of the client computing unit is suitable for accessing the services of the server programs of all server computing units.

In the method according to the present invention, data are accessed from a plurality of server computing units by a client computing unit. In contrast to known server/client models, in which many clients query one server, in the method according to the present invention one client queries many servers. Only queries from this client program are, for example, allowed by the server programs.

This new server/client model was designated as the “inverted server/client model” and “inverted client/server model” in the priority application. The term “inverted client/server model” is hereinafter used.

In a method according to the present invention, under the inverted client/server model a client computing unit operates as follows:

the client computing unit initiates queries, e.g. for data,

waits for and receives responses from the queried server computing units, and if applicable, receives alarms from appropriate server computing units, and

if applicable, interacts with measuring instruments or other applications via the corresponding server computing unit.

The server computing units work in conjunction with the client computing unit as follows:

they stand in readiness, i.e., they initiate neither queries nor activities, but they do initiate alarms,

they are connected to the network and respond only to queries from the client computing unit, and

they can be installed, uninstalled, and provided with current versions of programs or with new programs, for example, by means of the client computing unit.

The server computing units are provided with an identifier for the corresponding client computing unit and respond only to queries from this authorized client computing unit.

In each server computing unit, the processing of the data can, for example, be carried out by at least one microserver.

The processing of the data in the server computing units of the measurement stations, which are present in large numbers and may be similar to one another, is carried out by at least one microserver. Individual measurement stations can, if applicable, have additional alternative servers.

A microserver, which is accommodated in, e.g., a small electronic component, carries out the following for the process steps mentioned above, where applicable:

acquisition of data from the measuring instruments via different protocols and techniques of near-field communication, also known as near-field telemetry or in-house telemetry,

control of the measuring instruments, where applicable,

processing of the acquired data so that they are network-compatible, i.e., Internet-compatible.

Such a microserver also fulfills the function of an intermedial multi-utility server, iMUS, also referred to as an interactive multi-utility server. The use of microservers in a method according to the present invention makes possible an economical and convenient method in accordance with the inverted client/server model.

The measuring instruments and, where applicable, any additional devices can, for example, be controlled by the microservers.

Data can, for example, be acquired from at least one measuring instrument implemented as a simple house service meter and are processed and made available by a microserver. In a method according to the present invention, the use of microservers also permits the use of simple house service meters. Simple house service meters are, for example, economical electronic house service meters.

In an embodiment of the present invention, data are acquired from at least one measuring instrument implemented as a household appliance with at least one sensor and are processed and made available by a microserver.

In addition to the acquisition of data from sensors from household appliances, in an embodiment of the present invention, data for control are transmitted by a microserver to at least one measuring instrument implemented as a household appliance with at least one actuator or to an additional device with at least one actuator.

The use of microservers also permits data acquisition from sensors and data transmission to actuators of additional measuring instruments implemented as household appliances or of additional devices.

The data acquired from the measuring instruments can, for example, be prepared as XML documents in the server computing units during processing into client-compatible data.

The data acquired can, for example, be encrypted in the server computing units are decrypted in the client computing unit. This makes it possible to establish what is known as a Virtual Private Network VPN over the Internet, thereby permitting, for example, secure communication between the client computing unit and the server computing unit.

An embodiment for encryption and hence for a secure communication that corresponds to the functionality of a Virtual Private Network VPN is accomplished, e.g., as follows: queries to the server computing units are made exclusively from one client computing unit, or a very small number of client computing units, known to the server computing units. The server computing units recognize and process only queries from the client computing units known to them.

The data made available by the server computing units can, for example, be accessed by the client computing unit with the aid of a data module, for example, with the aid of a repository containing system data.

Upon query by at least one application module, data from the server computing units can, for example, be accessed by the client computing unit and forwarded to the application module. Application modules, also called applications, comprise application program units such as analysis programs and archiving programs.

The application modules have one or more modules. The modules are, for example, implemented as user modules that a third party, i.e., an end user, can access, as service modules with which, e.g., the contractual relationships between electricity producers, suppliers and end users are managed, as operating modules with which measuring instruments implemented as, e.g., meters, are monitored and controlled, and/or as modules for additional applications, for example, for acquiring data from measuring instruments implemented as household appliances and for controlling the measuring instruments or the additional devices. An example of an end user is an energy consumer.

In an embodiment of the present invention, data are queried, i.e., accessed, by at least one end user by means of at least one application module, for example, including a user module.

In an embodiment of the present invention, data, for example for control, are forwarded to at least one server computing unit by the client computing unit upon query by at least one application module that includes a control module. The data are transmitted from the server computing unit to, for example, an actuator of a household appliance that is controlled thereby.

In an embodiment of the present invention, the data from at least one server computing unit are accessed through a DSL connection.

In an embodiment of the present invention, fixed addressing of the server computing units is employed for accessing the data from server computing units through DSL connections. In this case, fixed public IP addresses are assigned to each of the server computing units and are stored in a table together with the identifiers, i.e., their symbolic names.

In an embodiment of the present invention, dynamically changing addressing of the server computing units can, for example, be used for accessing the data from the server computing units.

In this process, alternating public IP addresses are assigned to the server computing units in a certain rhythm. In an embodiment, the alternating public IP addresses are stored together with the identifiers in a table of a Domain Name Service DNS on the initiative of the server computing units.

In an embodiment of the present invention, the alternating public IP addresses are stored together with the identifiers in a table, e.g. of an SIP registrar, on the initiative of the server computing units with the aid of address management commands of the Session Initiation Protocol SIP. To this end, DSL connections are employed that have the capability of using address management commands of the Session Initiation Protocol SIP. A dynamically changing addressing through a DSL connection with the capability of using address management commands of the Session Initiation Protocol SIP can be carried out to access the data from at least one server computing unit.

An advantage of this method is that shared use can be made of DSL connections that already exist or will be acquired in future in many households, and hence in corresponding measurement stations, with the above-mentioned capability for addressing server computing units, i.e., with the capability to use address management commands of the Session Initiation Protocol SIP. A suitable DSL connection has a router, e.g. for IP telephones as well, with the capability of using voice-over IP VoIP and in addition the Session Initiation Protocol SIP. The use of special connections, such as separate DSL connections, or of GPRS/UMTS connections, is not necessary in this method. Nor is complex programming of an existing DSL router for a Domain Name Service DNS needed.

A distributed system according to the present invention for acquiring and managing data from a plurality of measuring instruments with the device is well suited for carrying out a method according to the present invention. The distributed system described herein is suitable for carrying out a corresponding method according to the present invention.

A distributed system according to the present invention for acquiring and managing data from a plurality of measuring instruments has multiple measurement stations, each of which includes at least one measuring instrument and a server computing unit. The distributed system also has at least one client station, which includes a client computing unit. The distributed system utilizes a communications network, such as the Internet, wherein the data made available by the server computing unit can be accessed through the communications network with the client computing unit.

The server computing unit can, for example, have at least one microserver.

At least one of the measuring instruments that is connected to a microserver can, for example, be implemented as a simple house service meter, such as a simple, electronic house service meter. At least one of the measuring instruments connected to a microserver can, for example, be implemented as a household appliance with at least one sensor. At least one of the measuring instruments implemented as a household appliance, or at least one additional device, that are connected to a microserver can, for example, have an actuator.

The client station can, for example, have a data module, referred to, for example, as repository. The data module is associated with the client computing unit and contains system data. The data module can also contain acquired data. The data module may alternatively also be located outside the client station.

A distributed system according to the present invention can, for example, have at least one application module that is connected to the client computing unit. Application programs of the application module can be connected to the client computing unit and communicate with the client program.

In an embodiment of the present invention, the client station can have additional application modules. This means that one or more application modules are, for example, located in the client station.

In an embodiment of the present invention, one or more application modules can be located separately and can be connected to the client computing unit through the communications network or an alternative communications network.

In an embodiment of the present invention, the distributed system can have at least one end user who can query one or more application modules, i.e., can access data, through the communications network where applicable. At least one application module can thereby include a user module for the end users. The end users can be connected by, for example, the communications network to the application module that has the user module and forwards any queries of the end users to the client computing unit by means of its application programs.

In an embodiment of the present invention, the distributed system can have at least one application module that includes a control module for measuring instruments.

In an embodiment of the present invention, at least one server computing unit of the distributed system can be connected to the communications system through a DSL connection with the capability of using address management commands of the Session Initiation Protocol SIP. The DSL connection can, for example, have a DSL router with this capability. Such a DSL router, for example, a VoIP-compatible and thus SIP-compatible DSL router, is already present in many households, and its use can be shared for addressing, and specifically for associating the identifiers having the private IP addresses in the domestic area of a measurement station with the public IP addresses.

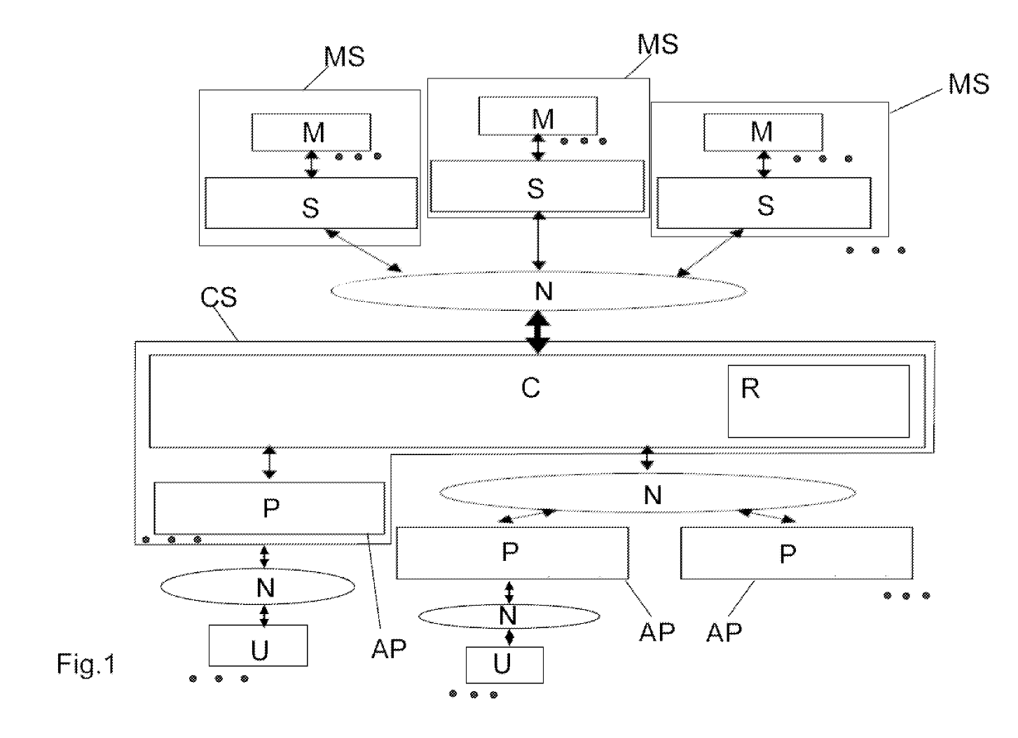

FIG. 1 shows a block diagram of a first distributed system according to the present invention for acquiring and managing data from a plurality of measuring instruments M according to the inverted client/server model. It comprises a plurality of measurement stations MS, each of which comprises at least one measuring instrument M and a server computing unit S. The server computing units S control the measuring instruments M and are connected to a communications network N. In FIG. 1, three of many measurement stations MS can be seen, each with one of several measuring instruments M and a server computing unit S.

The distributed system according to the present invention has at least one client station CS, which includes a client computing unit C and a data module R, for example a repository containing system data.

The client computing unit C is likewise connected to the communications network N. With the client computing unit C, the data made available by the server computing units S of the measurement stations MS can be accessed through the communications network N. The data module R is associated with the client computing unit C and is designed as a database, for example, which contains as a repository all system data required for operation.

The distributed system has at least one application module AP which is connected to the client computing unit C via at least one application program P.

On the left side of FIG. 1 is one application module AP of several application modules AP, the application program P of which is directly connected to the client computing unit C. This application program P is located, for example, in the client station CS on the computing unit that contains the client computing unit C, and is connected to the client computing unit C through an internal inter-process communication module instead of through the communications network N.

FIG. 1 shows two more of the several application modules AP, which are located in separate application stations and whose application programs P are connected to the client computing unit C of the client station CS over the communications network N.

The application modules AP include, for example, user modules, service modules, operating modules, and/or modules for additional applications, e.g., control modules for household appliances.

At least one application module AP can be queried by the an end user U. At least one application module containing a user module is provided with an application program unit P as a user program unit which can be accessed by a third party such as an end user U. End users U of the distributed system can, for example, be connected to this application module AP over the communication system.

In FIG. 1, end users U are connected to both the application module AP that is directly connected to the client computing unit C and to an application module AP that is connected to the client computing unit C over the communications network N. These application modules AP include user modules.

The other measurement stations MS, measuring devices M, application modules P and end users U that are not shown are symbolized in FIG. 1 by “ . . . ”. Bidirectional data exchange, represented by double-headed arrows, is possible between the elements of the distributed system, which may be connected to one another over the communications network N.

The communications network N is the Internet.

In an embodiment that is not shown, at least one end user U can be connected directly to one or more application modules P.

In an embodiment of the distributed system, one or more application modules AP can beconnected to the client computing unit C over a wide-area network or over a local communications network or through inter-process communications modules.

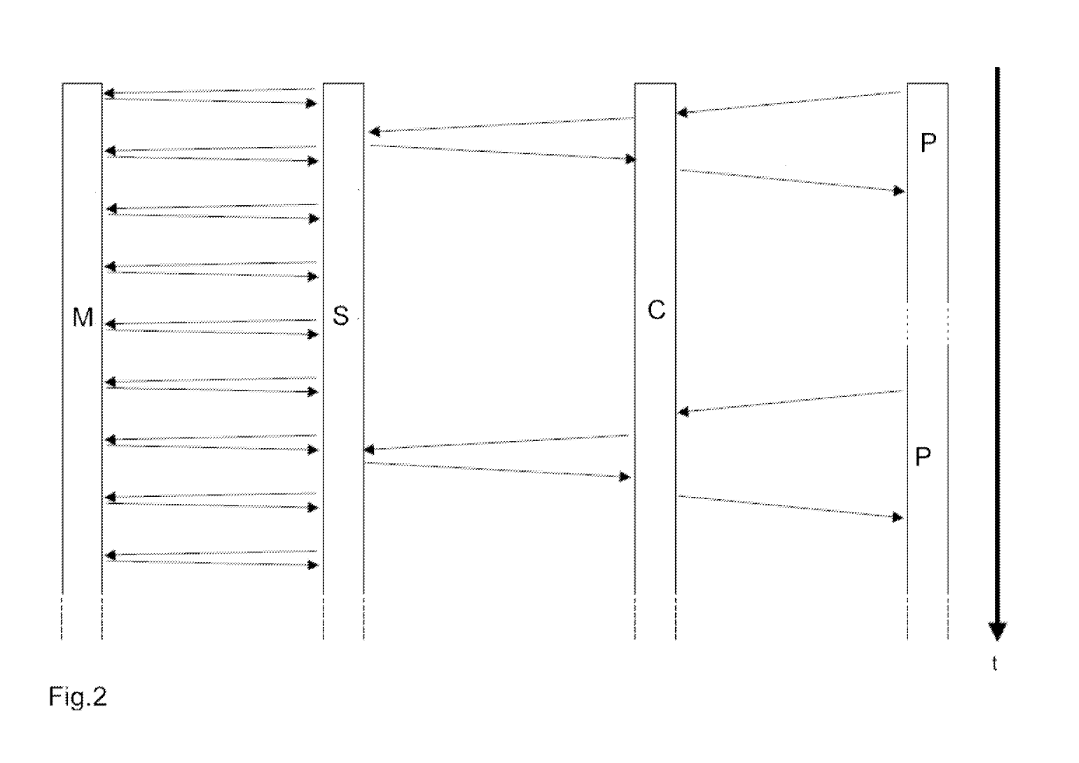

For acquiring and managing data from a plurality of measuring instruments M, data in each of the measurement stations MS can be acquired from at least one measuring instrument M. FIG. 2 shows a sequence diagram for the principle of data acquisition from a measuring device M in the distributed system according to the present invention. As a function of time t, shown as a time arrow at the right-hand edge of FIG. 2, the server computing unit S and the one measuring instrument M that is shown exchange data repetitively, i.e., at regular intervals. This data exchange is set forth on the left-hand side of FIG. 2. In this process, the server computing unit receives, for example, the current measurement value from the measuring instrument M in each case.

These acquired data, for example, the measurement values, are processed into client-compatible data and made available in the server computing unit S. The data from the measurement stations MS that are made available are accessed over the communications network N, the Internet, and further processed in the client station CS with the client computing unit C.

In response to a query occurring at an arbitrary point in time from an application program unit P of an application module AP, if applicable through the communications network N, the client computing unit C can access the corresponding data made available by the server computing unit S through the communications network N and forwards these data to the application program unit P of the application module AP. The queries of the client computing unit C is shown in the center, and the queries of the application program unit P is shown on the right side of FIG. 2.

The data made available by the server computing unit S are accessed by the client computing unit C, on request of an end user U if applicable, through an application module AP including a user module.

In order to acquire and manage data from a plurality of measuring instruments M which are associated with the measurement stations MS, for example, domestic measurement stations, the server computing units S acquire parallel data from the measuring instruments M, process them into client-compatible data, and make them available. Management of the acquired data takes place as early as in the server computing units S.

In the server computing unit S, the data that are acquired regularly, e.g. cyclically, are stored and are made available for the client computing units C to access. The server computing unit S also makes available data that are acquired dynamically, e.g., currently acquired measurement data such as usage data, upon request of an application module AP through an access by the client computing unit C.

The data made available by the server computing units S are accessed and further processed by the client computing unit C. An example of the further processing is a forwarding to an application program unit P whose query caused the client computing unit C to access the data.

During processing of the data into client-compatible data in the server computing units S, the acquired data are prepared as XML documents. The acquired data, such as XML documents, can be encrypted. After access through the communications network N, for example, through Internet protocols, e.g. HTTP protocols, the encrypted data can be decrypted in the client computing unit C.

The data made available by the server computing units S can be accessed by the client computing unit C with the aid of a data module R associated with the client computing unit C. The data module R contains all system data of the elements of the distributed system, which are used for purposes including verification of the authorization of, for example, querying application modules AP or for determining current Internet addresses from predefined symbolic names of the server computing units S.

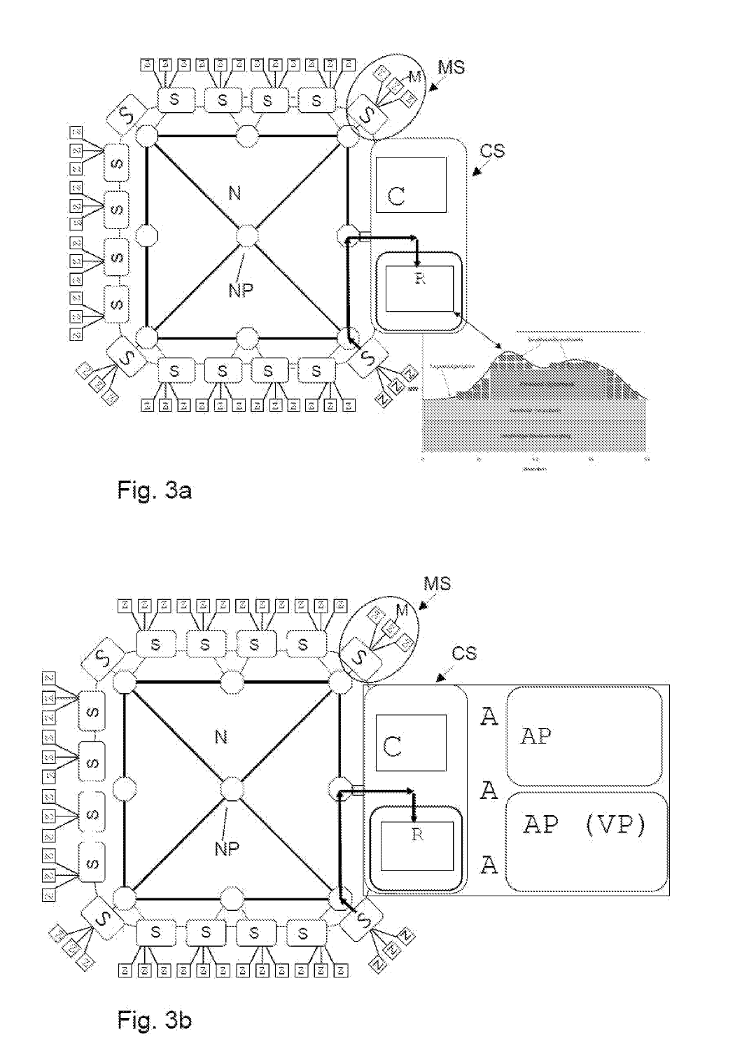

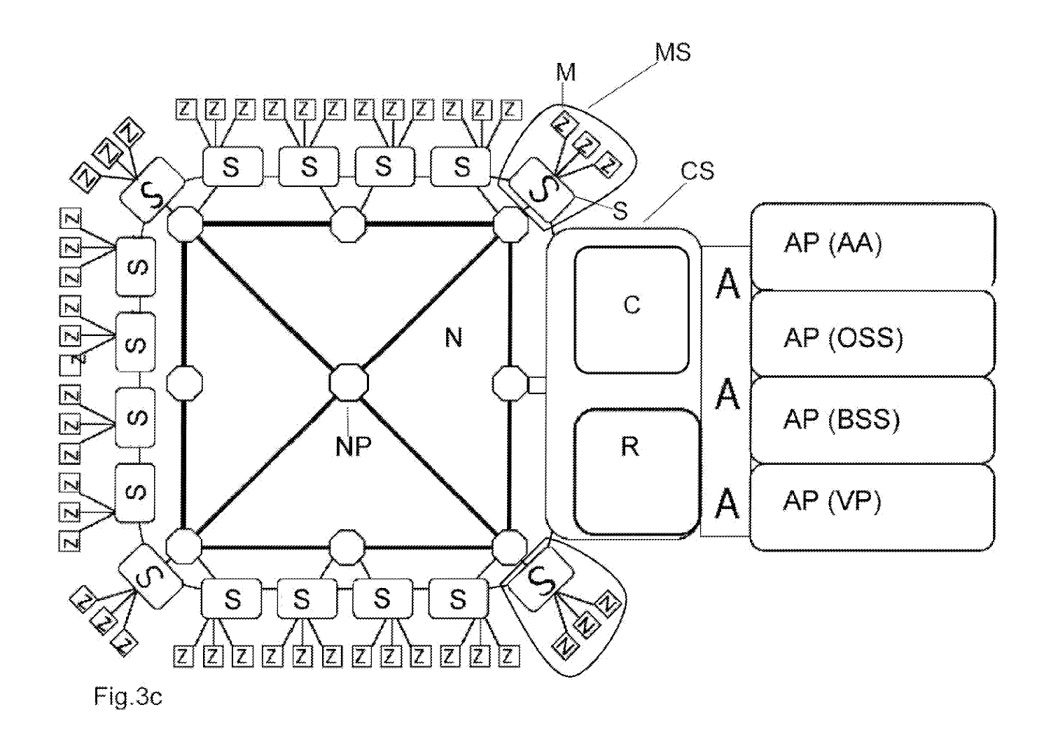

FIGS. 3a, 3b, 3c schematically show a different representation of the first distributed system for acquiring and managing data from a plurality of measuring instruments M. The figures show 16 of many measurement stations MS which include the measuring instruments M, in this case three measuring instruments M each, and a server computing unit S. The measuring instruments M are implemented as, for example, meters for electricity (electric meters), for heat, or for gas. The server computing units S are connected to the communications network N with network nodes NP. The communications network N is the Internet.

Also shown is the client station CS, which comprises a client computing unit C and a data module R, also referred to as a central repository. The client computing unit C is likewise connected to the communications network N, wherein the data from the measuring instruments M can be accessed with the client computing unit C through the server computing units S.

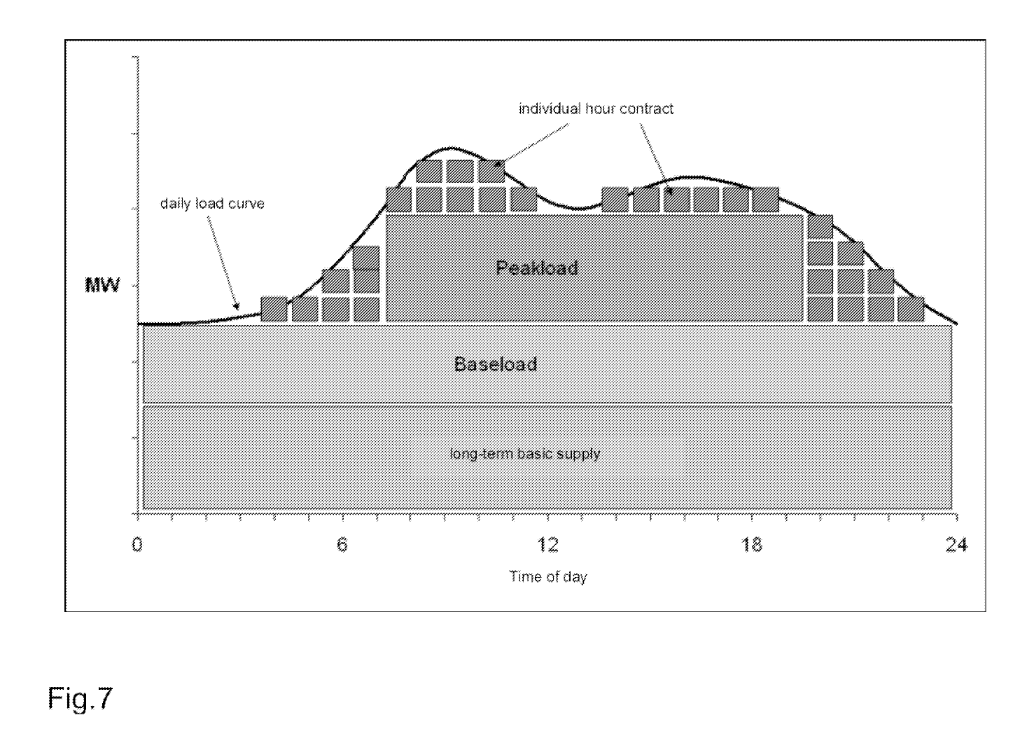

The usage profile of an end user U in conjunction with the client station CS, which is shown in FIG. 7 in an enlarged view, can be seen in FIG. 3a. The usage profile is an example of data that are acquired by a corresponding server computing unit S and, if applicable, forwarded through the client computing unit C with the aid of the repository R.

FIG. 3b shows the client station CS, which also includes application modules AP. Application modules AP are applications such as analysis programs. An application module AP can be configured as a user portal (user module VP), i.e., designed as an application program that a third party, such as an end user U, can access. Only authorized programs and authorized users (end users) can gain access (triple-A interface). At least one application module AP can be accessed by at least one end user U.

FIG. 3c shows a client station CS with a client computing unit C that is connected to four application modules AP through a triple-A interface. In this embodiment, the application modules AP are also located in the client station CS, wherein the triple-A interface symbolizes an internal connection (for example, an internal inter-process communications module) through which the application modules AP can access the client computing unit C. The application program units of the application modules AP are not shown in FIGS. 3b and 3c.

Application program units of additional application modules AP not shown in FIGS. 3b and 3c are connected to the client station CS through the communications network N, as already noted. The connection of the separate application modules AP to the client station CS through the communications network N also takes place in accordance with a triple-A interface.

In an embodiment, all application modules AP can be connected to the client station CS through the communications network N.

The data exchange between the measuring instruments M and the server computing units S takes place through near-field communication, which is to say through in-house telemetry.

The server computing units S can be connected through network nodes NP to the communications network N, namely to the Internet. In principle, the server computing units S are also connected to one another through the communications network N, as is indicated by connecting lines. Since no Internet addresses of other server computing units S are known to the server computing units S, nor is any corresponding client program installed on the server computing units S, the server computing units S cannot and should not communicate with one another.

Access to the client computing unit C is only possible for authorized programs of the application module AP, i.e., to authorized application program units P, and to end users U (consumers) authorized there through. The connection between the application modules AP, specifically their application program units P, and the client computing unit C, is automatically secured. In the case of queries of the application program units P, the securing takes place through verification of authenticity, authorization, and accounting using the system data stored in the data module R. The verification is symbolized in FIGS. 3b and 3c by three As. The corresponding interface is referred to as a triple-A interface (triple A: Authentication, Authorization, Accounting).

The four application modules AP shown in FIG. 3c are implemented as the user module VP (user portal), the service module BSS (business support systems), the operating module OSS (operations support system), and the module AA for additional applications. At least the application module AP implemented as the operating module includes at least one control module.

With a user module VP, end users U have made available to them information such as individual, current, and historical information on the measuring instruments M of their household, i.e., their measurement station MS. With a service module BSS, the contractual relationships between electricity producers, suppliers, partners, and end users U are, for example, managed. With an operating module OSS, the measuring instruments M are, for example, monitored and, if applicable, controlled. For example, with a control module of an operating module OSS in the form of a remote maintenance module, installation data of the measuring instruments M can be passed in or out in the applicable measurement station MS, i.e., forwarded to the server computing unit. An operating module OSS can, for example, be associated with a metering point operator. With a module AA for additional applications, additional household appliances are queried and controlled, for example.

In an embodiment of the present invention, two or more application modules AP can stand in relationship to one another and exchange data directly or over the communications network N or another communications network.

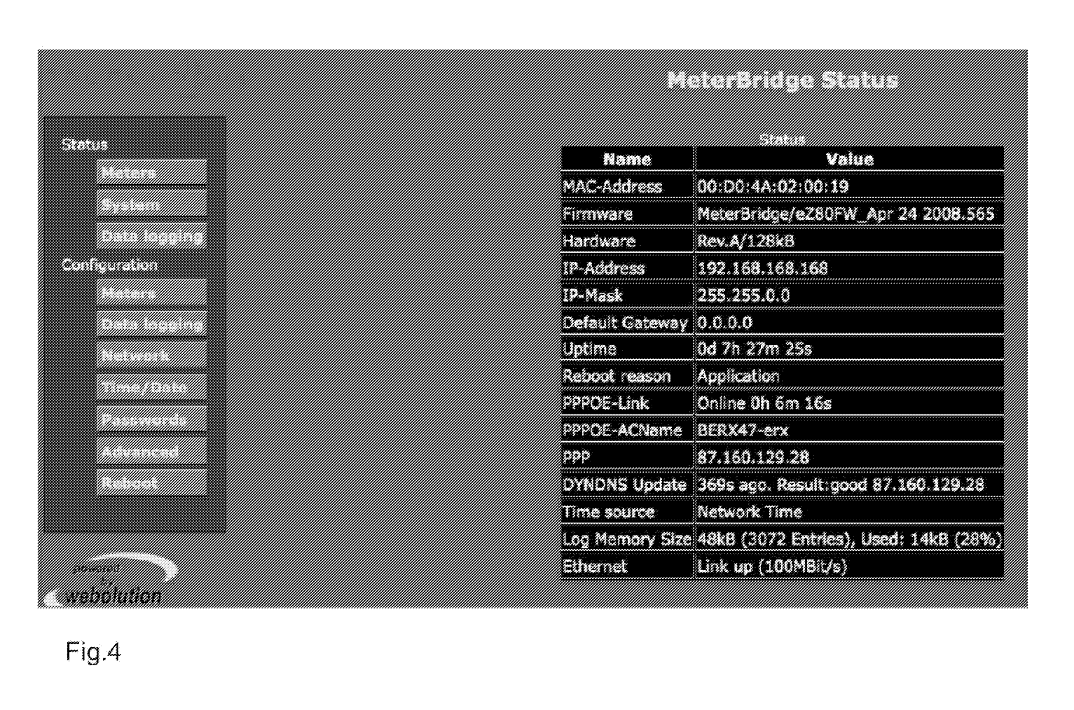

FIG. 4 shows an example of a display of an XML document with status data of a measuring instrument M. The XML document was prepared and made available by the applicable server computing unit S from the data acquired from the measuring instrument M and, for example, forwarded to the application program unit P by the client computing unit C with the aid of the data module R upon request of an application program unit P of an application module AP implemented as an operating module OSS. For the display shown in FIG. 4, the XML document was processed by the application program unit P, i.e., FIG. 4 shows an XML document that has already been format-interpreted.

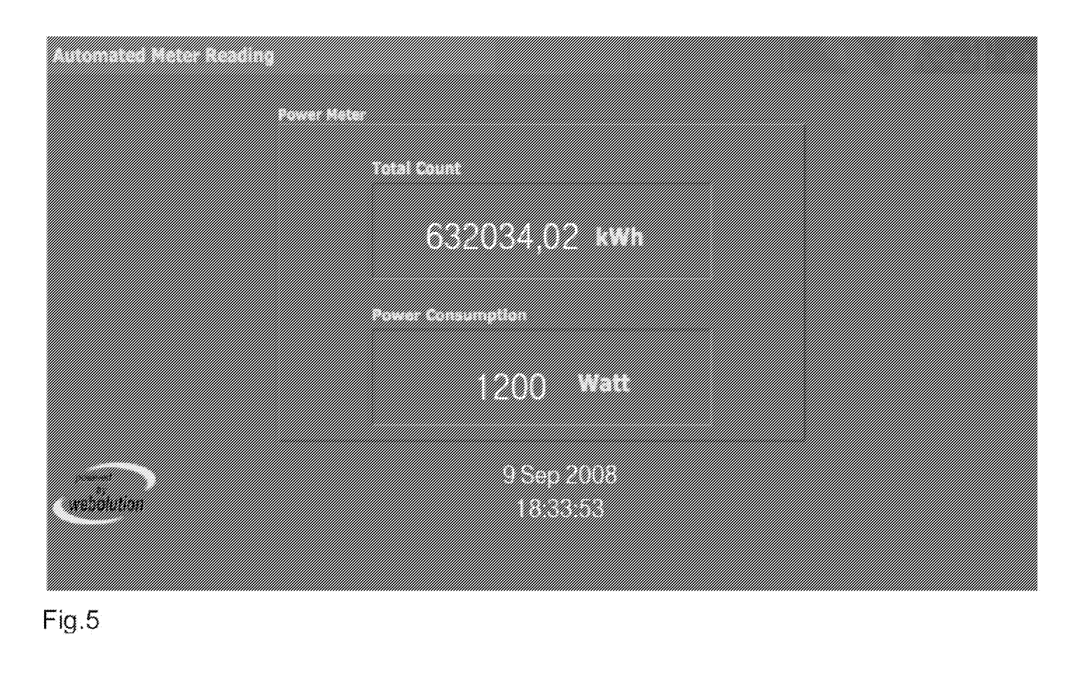

FIG. 5 shows another example of a display of a format-interpreted XML document, specifically an XML document with measurement data from a measuring instrument M that was forwarded to an application module AP implemented as a service module BSS or, for example, to an application module AP implemented as a user module.

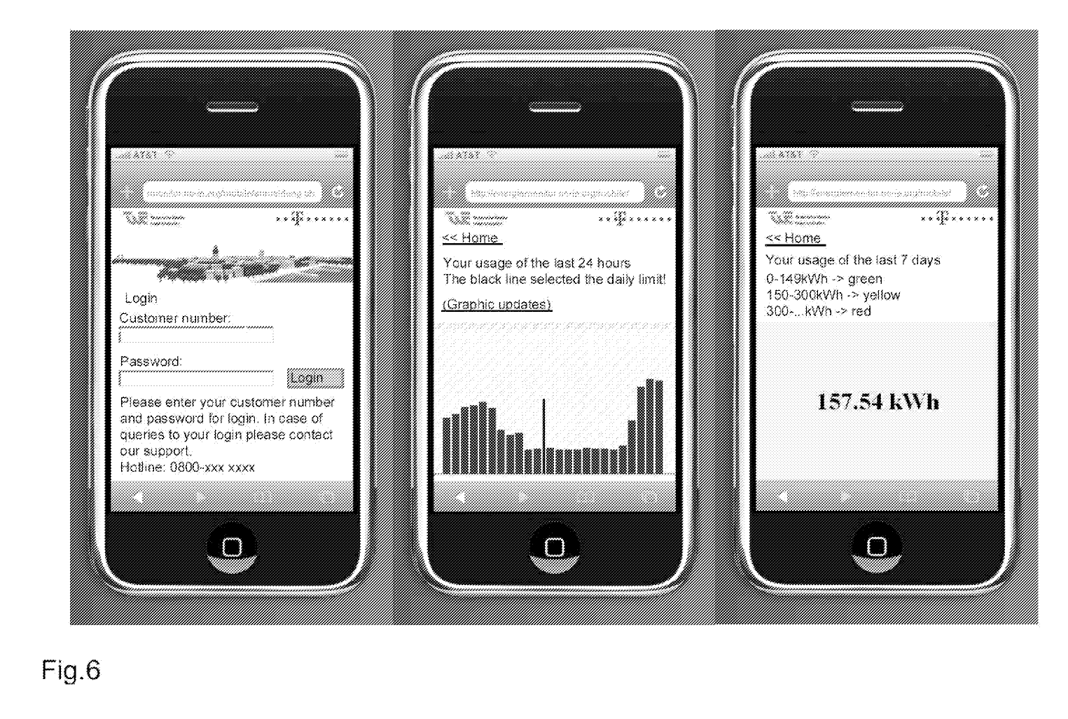

A query and output of measurement data of an SML document by an end user U can be seen in FIG. 6. The underlying XML documents with measurement data from a measuring instrument M, for example, an electric meter, were accessed from the server computing unit S managing the data by the client computing unit C, and transmitted to an application module AP implemented as a user module VP, where they were accessed by the end user U. The data were processed in the corresponding application program unit P, for example, with the power usage of the last 7 days of 157.54 kWh being compared in this example with usage ranges and displayed in color (for example, for a usage of 150 to 300 kWh). In this example, the determination of the power usage of the last 7 days takes place in the applicable server computing unit S and the value determined is made available as an XML document. A management of the acquired data thereby takes place in both the server computing unit S and the application program unit AP of the applicable application module AP.

FIG. 7 shows, by way of example, a 24-hour usage profile of an end user U determined from measurement data, which profile is divided among different load situations and thus among possibly different rate agreements. The usage profile is divided into a long-term, e.g., annual, basic supply, a base load, e.g., differing by season, a peak load, e.g., daily, and individual hours. The measurement data for this example are acquired from the applicable server computing unit S and are made available as XML documents. Via the client computing unit C, the measurement data have been forwarded to the application program unit P of the appropriate application module AP, in this case to a service module BSS for accounting of usage, for example, and are processed in accordance with the different rate agreements.

In an embodiment of the present invention, a data module R of a distributed system can include measurement data queried from the server computing units S in addition to the system data. In this embodiment, data, namely the measurement data and, if applicable, processed measurement data such as daily and weekly values or averages, are also managed in the data module R. In this design, measurement data, for example, that required for accounting, and/or processed measurement data can be forwarded from this unit of the data module R through the client computing unit C to the application program unit P of the applicable application module AP.

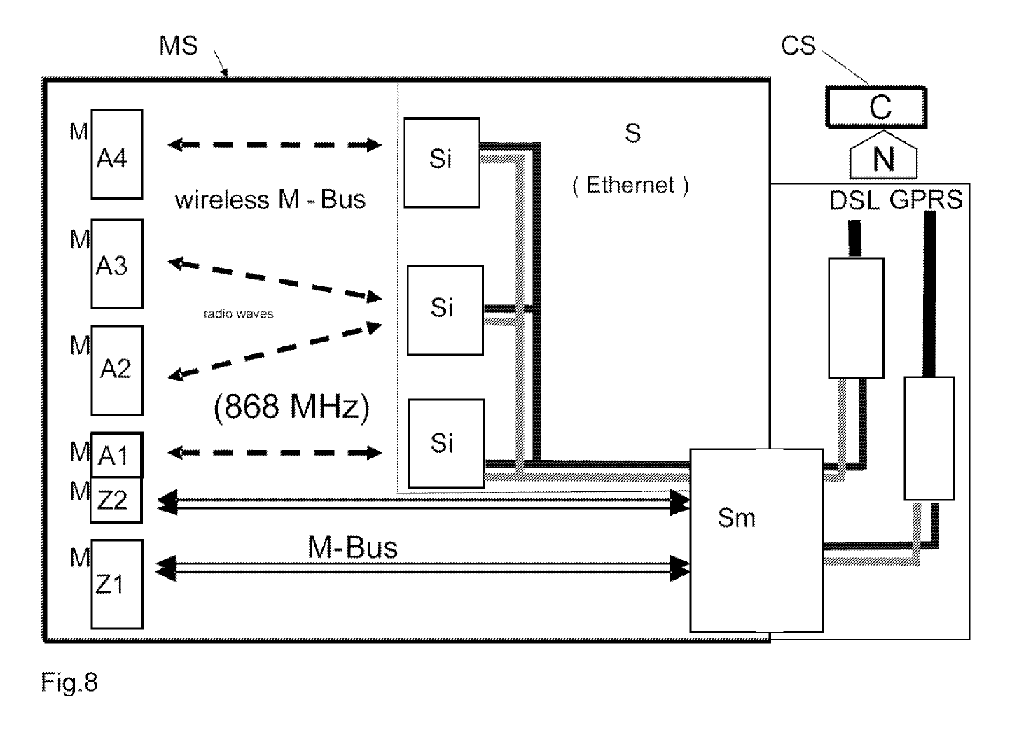

FIG. 8 shows one of the measurement stations MS from the first example of a distributed system according to the present invention with a server computing unit S and with measuring instruments M. The server computing unit S, as is the case with all such in this example, has at least one microserver Sm, Si. The measuring instruments M are connected to the microserver Sm, Si. At least one of the measuring instruments M is implemented as a simple house service meter Z1, Z2, and at least one of the measuring devices M of the distributed system is implemented as a household appliance A2 through A4 with at least one sensor and, if applicable, at least one actuator. For example, at least one measuring instrument M is implemented as a household appliance A2 for acquiring data, e.g., as a heat cost allocator.

In the measurement station MS shown in FIG. 8, the server computing unit S has a primary microserver Sm and three additional microservers Si. Some measuring instruments M of the measurement station MS are connected directly to the primary microserver Sm; for example, the measuring instrument M for electricity, namely a simple electronic house service meter Z1 for electricity, and the one for gas, namely a simple electronic house service meter Z2 for gas.

Additional measuring instruments M of the measurement station MS are connected to the microservers Si and are only connected to the primary microserver Sm through them. The additional measuring instruments M of the measurement station MS are implemented as additional electrical or electronic meters A1 and/or household appliances A2, A3, A4 with sensors and, if applicable, actuators, specifically as a water meter A1, a heat cost allocator A2, a household appliance A3 for measuring and controlling conditions affecting health, e.g., the humidity (health care), and a household appliance A4 for measuring and controlling devices in the domestic area, for example louvers (home care). The household appliances A3 and A4 have actuators.

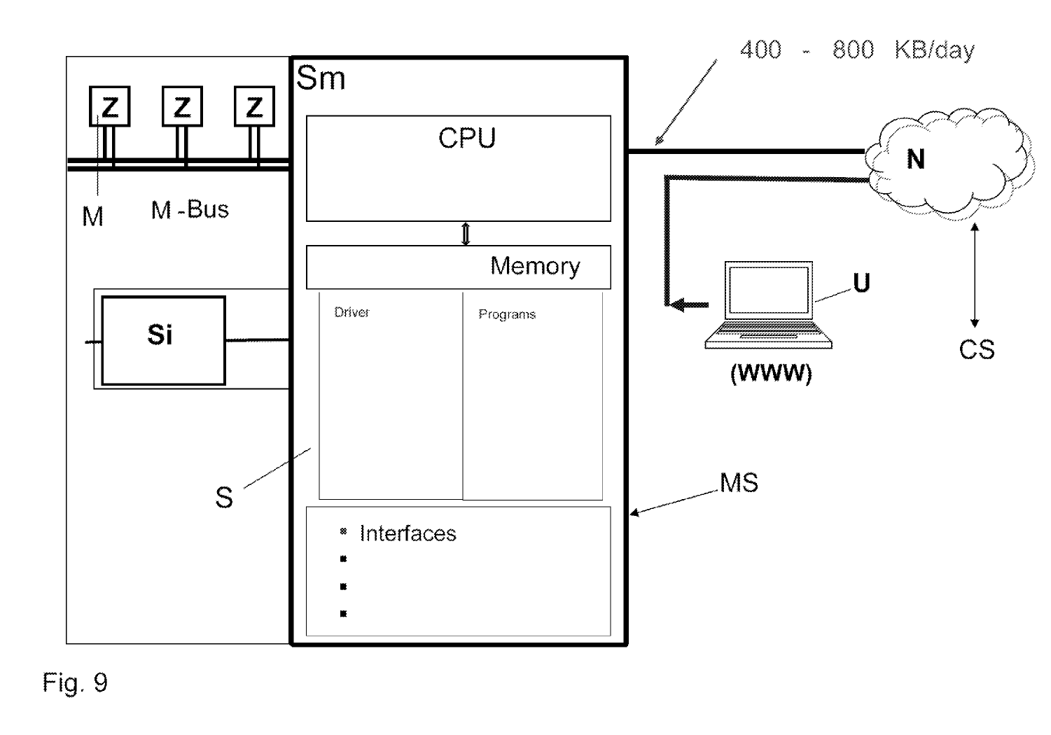

Simple measuring instruments, i.e., simple electrical house service meters Z1, Z2 connected directly to the primary microserver Sm, and for additional measuring instruments M, if applicable, measuring instruments M that are located at some distance such as meter measuring instruments M implemented as meters A1 and as household appliances A2, A3, A4, can, for example, be connected to the primary microserver Sm through microservers Si. This is also shown in FIG. 9.

In an embodiment of the present invention, at least one additional device, and specifically at least one actuator of the additional device, can be connected to one of the microservers Si.

One or more of the measurement stations MS can alternatively be equipped only with a microserver Sm and simple measuring instruments M.

FIG. 8 shows the equipping of the measurement stations MS with telemetry installed in the domestic area, which is made possible by means of at least one microserver Sm, Si (home iMUS farm: telemetry as in-house installation) as an interactive multi-utility server (also called an intermedial multi-utility server iMUS). At least the primary microserver Sm (main server), but in this example, also the three additional microservers Si (room servers), are implemented as interactive multi-utility servers. The simple electronic house service meters Z1, Z2 for electricity and gas are each connected to the primary microserver Sm through an M-Bus consisting of a two-wire copper cable. The household appliances A1 through A4 are, for example, connected to the microservers Si over wireless M-Buses of a local wireless network, a frequency of, e.g., 868 MHz (peripheral access communication). The additional microservers Si are connected to the primary microserver Sm, for example, through a wired communications system, e.g., Ethernet, in-house power line communication (HomePlug), or through a wireless communications system, e.g., WLAN. The primary microserver Sm is connected to the communications network N and through it to the client computing unit C. The connection of the primary microserver Sm, and thus the server computing unit S, to the communications network N, the Internet, takes place through a DSL transmission service and/or a GPRS transmission service and/or a UMTS transmission service.

FIG. 9 shows the structure of the primary microserver Sm of the measurement station MS from FIG. 8. The primary microserver Sm comprises a computing unit CPU, e.g., Zilog F91 (high-performance eZ80 Acclaim™, 8-bit microcontroller, up to 256 KB of reprogrammable Flash memory), a memory unit (Flash memory), drivers for various electric meters (including electronic house service meters EHZ), gas meters, heat meters (Minol) as well as programs, e.g., for querying electricity, querying gas, querying heat, storing daily cycles, accumulation and monitoring, as well as network units (interface programs, interfaces), e.g., Ethernet MAC (PPoE), TCP/IP, http (web server), etc. A data volume of 400 to 800 KB per day can be transmitted through at least one connection of the primary microserver Sm to the communications network N and thereby to the client computing unit C of the client station CS. FIG. 9 also shows the option of access to, e.g., acquired data by an end user U over the communications network N, the Internet (e.g., www). The microservers Sm, Si of the server computing unit S, implemented as interactive multi-utility servers, serve as intermediaries between the in-house telemetry, i.e., the acquisition of data from the measuring instruments M and if applicable the control of the measuring instruments M in the domestic area, and the client computing unit C acting over the communications network N, i.e., an information and communications technology (IKT). A maximum of 31 meters can be connected to these special microservers Sm, Si.

Here, domestic telemetry or in-house telemetry designates a system with components and methods for data transmission between the server computing unit S, specifically the microservers Sm, Si, and the measuring instruments M, namely the meters Z1, Z2 through permanently installed lines, and the additional measuring devices M over wireless connections. In-house telemetry includes the systems known at present, e.g. for reading and controlling meters Z1, Z2 that have sensors (classic telemetry from sensors), systems for heat cost allocation with data acquisition units called heat cost allocators, and systems for monitoring and controlling additional devices via actuators in the domestic area (telecommanding of actuators in the household).

In operation, the acquisition and processing of the data in each server computing unit S is performed by at least one microserver Sm, Si, by which the measuring instruments M are also controlled.

The data from the measuring instruments M implemented as simple house service meters can be processed by the primary microserver Sm. The data from the additional measuring instruments M can be acquired by additional microservers Si, processed if applicable, and can be further processed, if applicable, and made available in the primary microserver Sm.

In the processing of the data acquired from the measuring instruments M, XML documents can be prepared by the microservers Sm, Si. The microservers Sm, Si encrypt the acquired data. The data are decrypted in the client computing unit C.

Data from the simple electronic house service meters Z1 and Z2 for electricity and gas can be acquired, transmitted to the primary microserver Sm through the copper line M-Bus, and processed into client-compatible data and made available by said microserver. Data can likewise be acquired from the water meter A1, the heat cost allocator A2, and the household appliances A3 and A4. These data can be transmitted to the additional microservers Si over the wireless network. The microservers Si send the acquired data through the local network, e.g., Ethernet, to the primary microserver Sm, in which they can be processed into client-compatible data and made available.

Upon query from at least one application module AP, the data from the different measuring instruments M made available in the primary microserver Sm of the server computing unit S can be accessed over the Internet from the client computing unit C with the aid of the data module R and can be forwarded to the application module AP. An authorized end user U can access acquired data from the measuring instruments, and if applicable control measuring instruments M, over the Internet, over an appropriate application module AP, and over the client station CS. For example, the data can be acquired from the sensors of the simple house service meters Z1, Z2 and/or the meter A1 and/or the household appliances A2 through A4. The corresponding application module AP can include, for example, a user module and a control module. Upon query by the user module, acquired data can be accessed by the client computing unit C. Upon query by the control module, data for control can be forwarded to the server computing unit S and, for example, from the corresponding microservers Si of the server computing unit S to the actuators of the household appliances A3, A4.

Acquired data can also be processed into client-compatible data and made available directly in the additional microservers Si.

One or more of the measurement stations MS can alternatively be equipped only with a microserver Sm and, if applicable, with simple measuring instruments M.

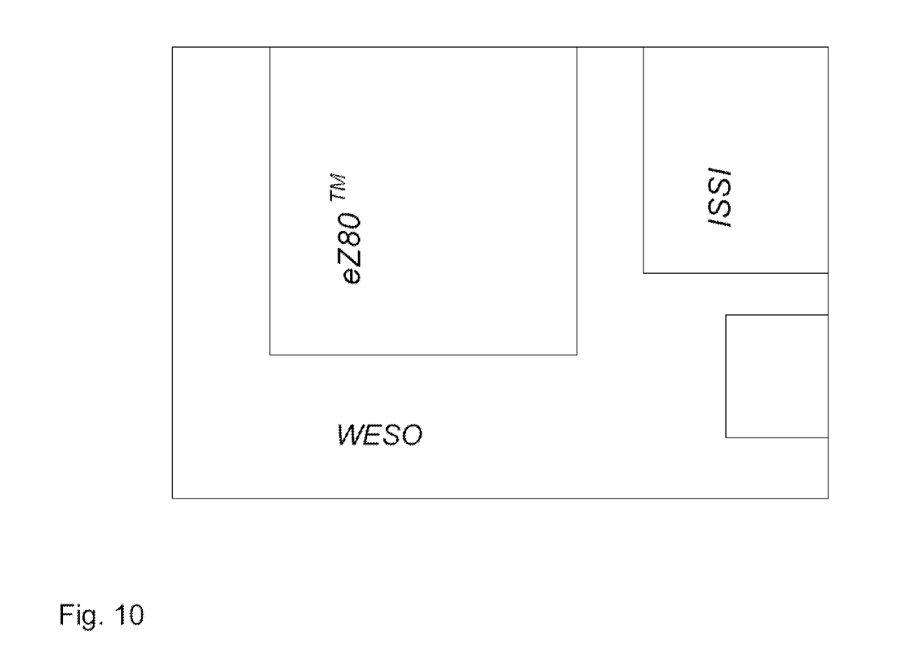

FIG. 10 shows an electronic component with a microserver Sm, Si from the Webolution company. The width of this electronic component is 2 cm and its length is 3 cm. The electronic component containing the microservers Sm, Si can be mounted on the DIN rail in a meter box, for example.

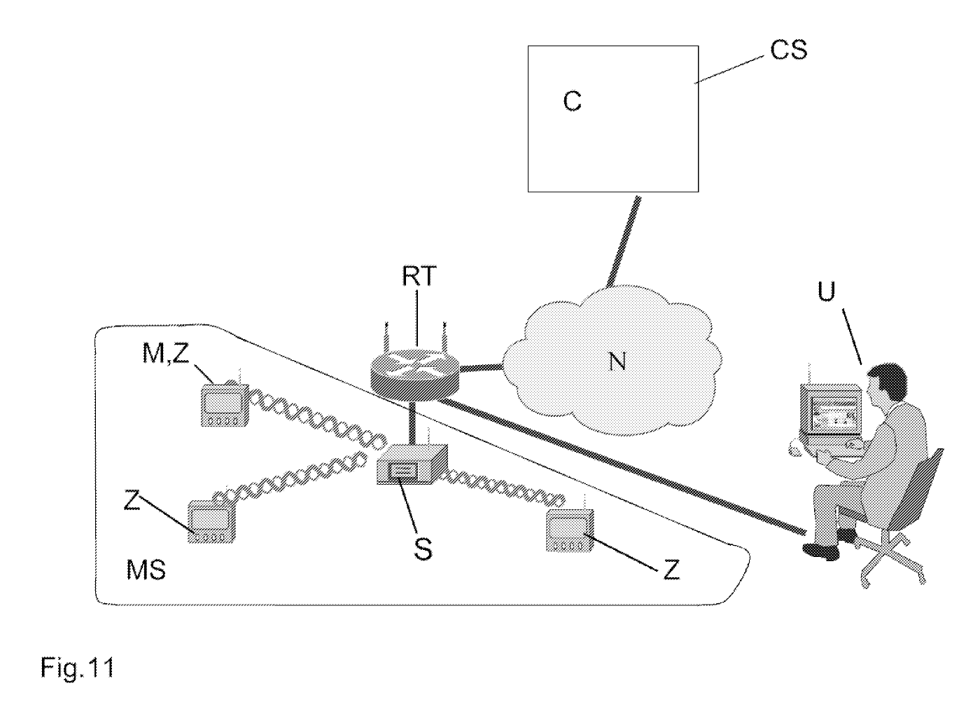

FIG. 11 shows a measurement station MS in which the measuring instruments M can be connected directly to the microserver Sm of the server computing unit S. FIG. 11 shows that the server computing unit S can share the use of an existing Internet connection (router RT). This is described in FIG. 5 of the priority application. In addition, FIG. 11 shows a client station CS, with a client computing unit C, connected to the communications network N.

FIG. 11 shows a measurement station MS with three measuring instruments M, which are implemented as meters Z. In this design, the measuring instruments M are connected directly to a microserver (iMUS), not shown, of the server computing unit S. The server computing unit S is connected to the communications network N, the Internet, through the router RT. FIG. 11 shows that this router RT is also used by an end user U associated with the measurement station MS in order to exchange data over the communications network N. FIG. 11 therefore shows that the server computing unit S can share in the use of an existing Internet connection, namely the router RT.

57.9% of private households in Germany have an Internet connection (and 95.2% have a fixed network connection; Source: Statistical Yearbook 2007, the German Federal Statistical Office [Statistisches Bundesamt]). Shared use can be made of these private Internet connections for a distributed system according to the present invention for energy and supply management, for example, initially only for automatic remote reading (AMR), thus saving costs. The server computing unit S having an interactive multi-utility server (iMUS) can collect the data of the measuring instruments M implemented, for example, as simple, electronic household meters Z (smart meters), and transmit the data upon request over the communications network N, the Internet, to the client computing unit C. The router RT can be implemented as a WLAN router. The measuring instruments M are a gas meter Z, a water meter Z, and an electric meter Z.

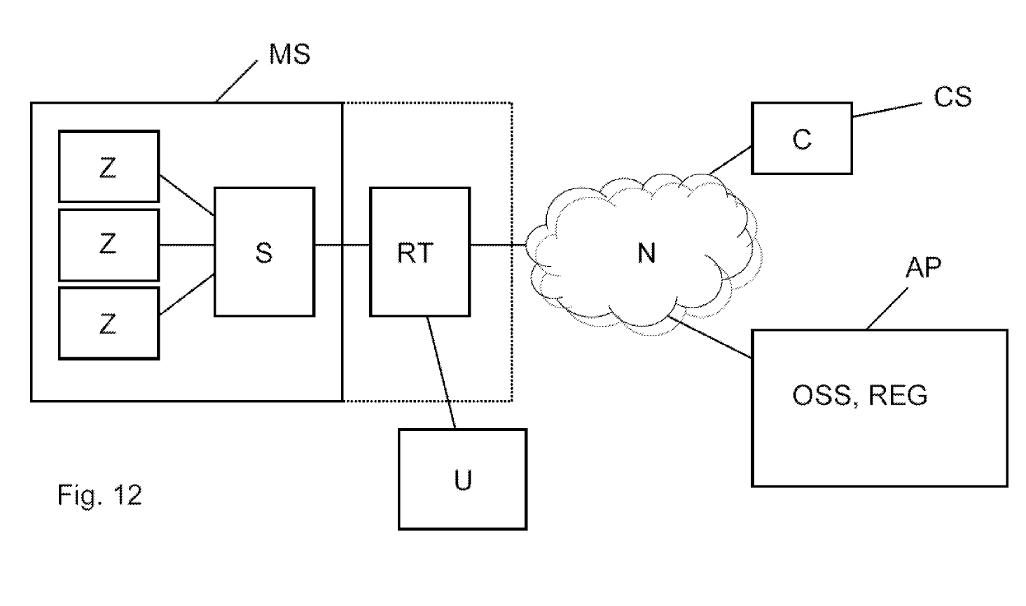

FIG. 12 shows an embodiment of the measurement station from FIG. 11. The server computing unit S has a DSL connection and is connected to the communications network N, the Internet, through the router RT implemented as a DSL router. The DSL connection, and specifically the router RT, has the capability to use address management commands of the Session Initiation Protocol SIP.

In addition to the client station CS with the client computing unit C, an application module AP with an operating module OSS and a SIP registrar REG are connected to the communications network N. A SIP registrar REG is a database with appropriate programs for reading and writing SIP-relevant information.

The data of the measuring instruments M, implemented here as meters Z, are acquired and made available as XML documents by the server computing unit S. Dynamically changing addressing through the DSL connection is used for accessing the data from the server computing unit S. The data are accessed by the server computing unit S through the router implemented as a DSL router, wherein address management commands, i.e., appropriate protocol elements and functions, of the Session Initiation Protocol SIP are used.

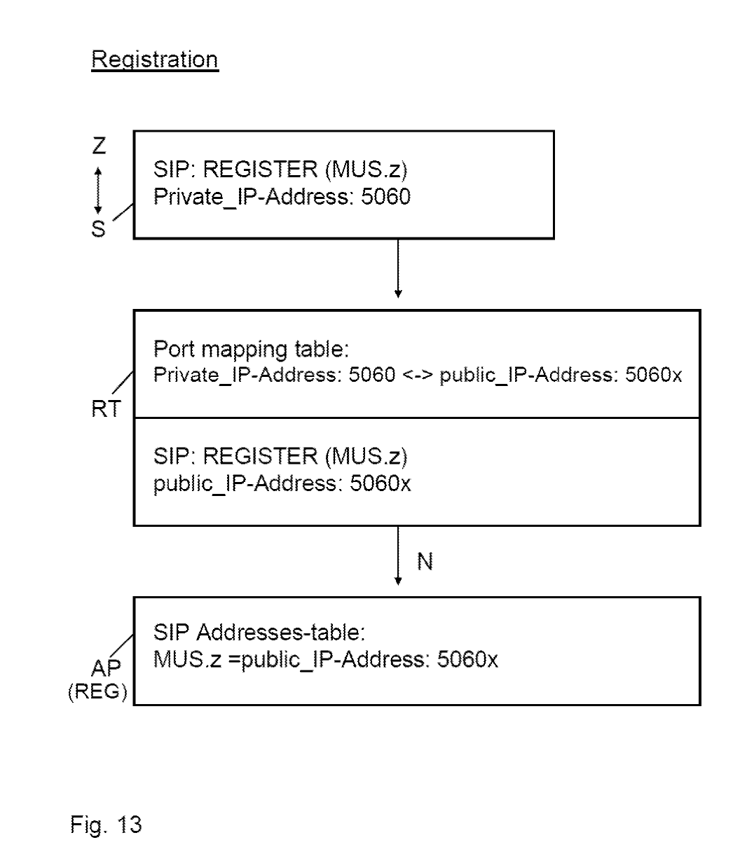

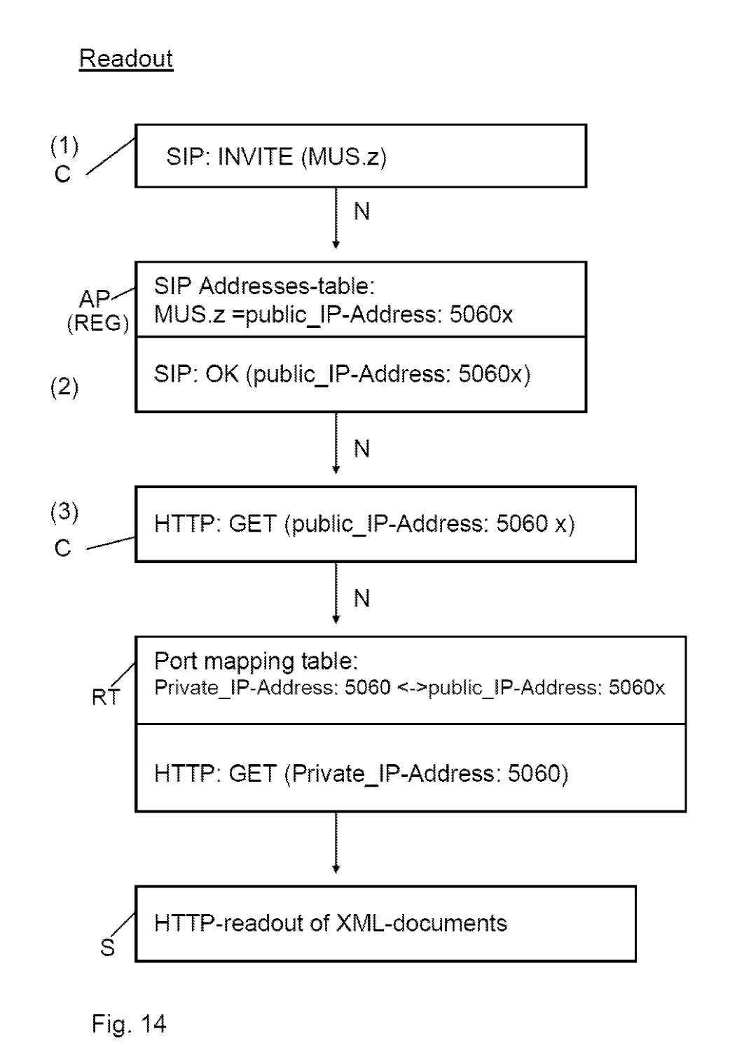

Registration of the server computing unit S with the meters Z and accessing of the data acquired by the server computing unit S from the meters Z are represented in FIGS. 13 and 14. For registration, the server computing unit S transmits the SIP command REGISTER with its symbolic name MUS.z and its private IP address to the router RT, which maintains a Port Mapping Table, in which the private IP addresses are associated with public IP addresses. The router RT forwards the SIP command REGISTER with the name MUS.z and the public IP address to the SIP Registrar REG of the application module AP. The SIP Registrar REG maintains a SIP address table, in which the forwarded association is stored.

In a query of an application module AP to the client computing unit C regarding data of a meter Z that are made available with the name MUS.z on the server computing unit S, said client computing unit first determines the public IP address of the server computing unit S with the SIP command INVITE at the SIP Registrar REG, whereupon the SIP Registrar REG returns this address with the SIP command OK. Next, using the HTTP protocol, the client computing unit C forwards the request for the data of the meter Z at this address to the router RT, which uses the address of the server computing unit S to forward the request to the same. The requested XML documents with the data of the meter Z that the server computing unit S had made available are accessed, and are transmitted through the reverse path via the client computing unit C to the requesting application module AP.

In an embodiment of the distributed system according to the present invention, many of the measurement stations MS have server computing units S with DSL connections, in some cases already existing, with the capability of using address management commands of the Session Initiation Protocol SIP. According to the present invention, dynamically changing addressing of the server computing units S through these DSL connections is used in order to access the data. This allows simple implementation of a dynamically changing addressing.

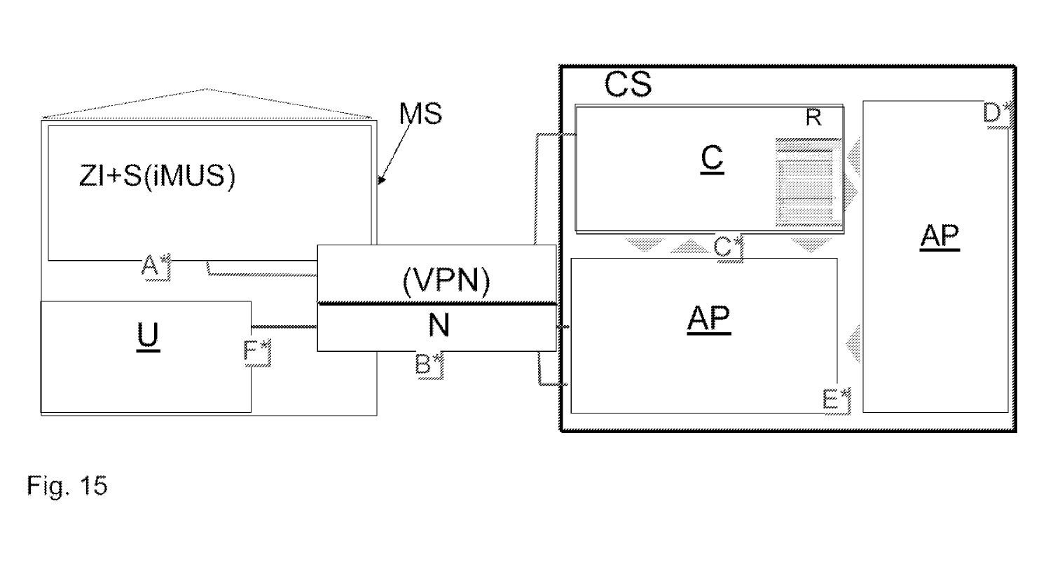

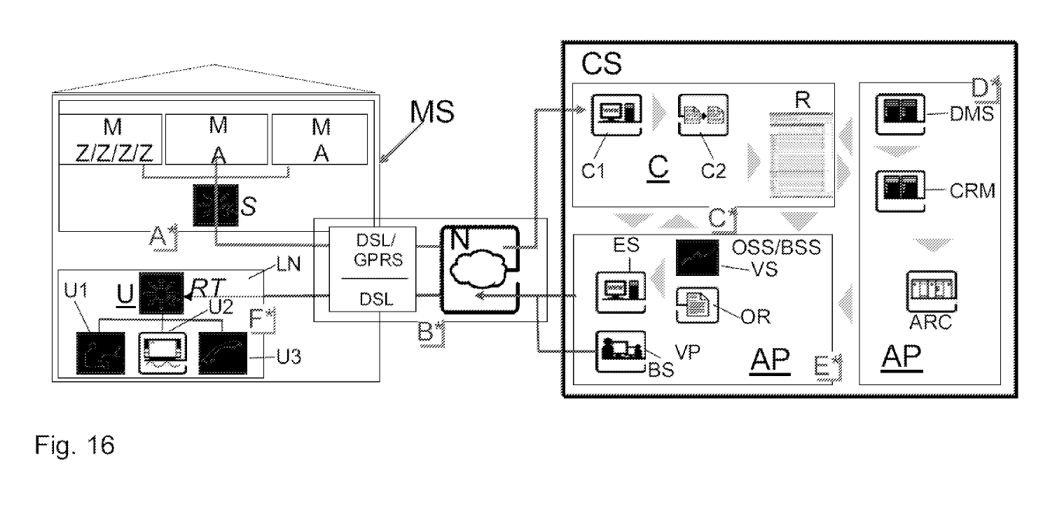

In FIGS. 15 and 16, a second distributed system according to the present invention is shown, wherein the distributed system and the corresponding method for acquiring and managing the data correspond to the first distributed system and its methods, with the exception of a few alternative and/or additional features described below. FIGS. 15 and 16 show the architecture of subsystems of the distributed system constructed according to the inverted client/server model using a measurement station MS and a client station CS. The modules and their functions can be seen in FIG. 16. The system according to the present invention is suitable for carrying out automatic remote meter reading (AMR) and additional services in the domestic area of the measurement stations MS (home services).

FIG. 15 shows one of many measurement stations MS of the distributed system, as well as an end user U, which are located in spatial proximity, for example, in a household. The measuring stations MS and the end user U are connected to the client station CS through the communications network N, specifically the Internet.

As can be seen in FIG. 16, the measurement station MS comprises multiple measuring instruments M and one server computing unit S. The measurement station MS comprises four measuring instruments M implemented as simple house service meters Z for electricity, water, gas, and heat, as well as one household appliance A for measuring and controlling the conditions in the household affecting health (health care), for example, for measuring vital data such as humidity, and a household appliance A for measuring and controlling, e.g., building devices such as louvers (home care). The household appliances A have sensors and actuators.

The server computing unit S comprises at least one microserver that is employed as an interactive multi-utility server (iMUS), and to which are connected the measuring instruments M. The measurement station MS has a measurement control system composed of the various measuring instruments M and the above-mentioned microserver, in which the data of the measuring instruments M are acquired and processed by the microserver and any additional devices are controlled by the microserver. The network-compatible microserver of the server computing unit S is connected to the communications network N and uses a DSL transmission service and/or a GPRS transmission service.

The end user U (home client) is equipped with a computing unit U1, for example a PC with a browser, with a display unit U2, and with a telephone unit U3, which are connected to one another through a local wireless network LN, for example WLAN. The local wireless network LN is connected to the communications network N through a router RT, for example a WLAN router.

The client station CS shown in FIG. 15 has a client computing unit C (AMR client) with a data module R (repository) containing system data. Located in the client station CS are two application modules AP, which are connected to the client station CS and to one another. One of the two application modules AP is connected to the communications network N.

As is shown in FIG. 16, the client computing unit C has a receiving and transmitting unit C1 and a processing unit C2 for combining the data. The latter is connected to the data module R.

One of the application modules AP, also referred to as an application platform, comprises a data unit for managing data DMS (Data Management System), a customer unit with customer data CRM (Customer Relationship Management), and an archive ARC, for example with form letters (lettershop). This first application module AP, and specifically the data unit DMS, is connected to the client computing unit C, and specifically to the data module R.

The second application module AP connected to the communications network, also referred to as a public server (Public Server, Web Service), comprises a module implemented as an operating and service module OSS/BSS, which generates usage statistics VS and online bills OR, for example, and makes these available to its receiving and transmitting unit ES. The second application module AP also includes a user module VP with a control module, which makes a consulting service BS available to the end user U.

The application module AP, for example, its archive ARC, is connected to the second application module AP, for example to the user module VP.

Encryption, known as a VP (virtual private) network VPN, is additionally established over the Internet. In this process, the data are encrypted by the server computing unit S and decrypted by the client computing unit C.

In order to acquire and manage the data from a plurality of measuring instruments M, i.e., to implement automatic remote meter reading (AMR) and additional services in the domestic area of the measurement stations (Home Services), the following services are specified as components in FIGS. 15 and 16:

A* device adaptation; measurement/control, encryption,

B* transmission of client/server protocols over IP,

C* measurement services, device monitoring, data collection,

D* data, customer, energy, & supply management,

E* consumer-oriented services,

F* entertainment, information, & telecommunications.

To acquire and manage data from a plurality of measuring instruments M, according to the present invention, the data in multiple measurement stations MS can be acquired from at least one measuring instrument M. The data in many measurement stations can be acquired from a large number of measuring instruments (for example, approximately 10⁴ measuring instruments) implemented as simple house service meters Z and as household appliances A. The acquired data are processed into client-compatible data and are made available in the server computing units S of the measurement stations MS. In this context, the microservers S of the server computing units acquiring the data operate in parallel.

During processing by the server computing units S, the acquired data can be prepared as XML documents and can be encrypted in accordance with the rules of the VP network. In addition to the data acquisition, the server computing unit S carries out device adaptations for the measuring instruments M and transmits data for control to the actuators of the measuring instruments M implemented as household appliances A. This corresponds to component A*.

The encrypted data from the measurement stations MS that are made available can be accessed over the communications network N, the Internet, in the client station CS with the client computing unit C with the aid of the data module R, and specifically with the aid of system data from the data module R. Internet protocols can be used as transmission protocols. The acquired data can be further processed, for example, decrypted, processed, and archived. This corresponds to component B*.

Upon request of an application program unit of an application module AP, data from at least one server computing unit S can be accessed and forwarded to the application program unit of the application module AP by the client computing unit C.

Upon request of the OSS/BSS module of the second application module AP, for example, usage data can be transmitted, and usage statistics VS can be determined from them in the OSS/BSS module. The usage data or other requested data can be used for monitoring the measuring instruments M. This corresponds to component C.

Depending on the type of usage data requested and depending on the breakdown of the management of the acquired data, the usage data may be transmitted from the data unit of the data module R or directly from the applicable server computing unit S or from the first application module AP.

Upon request of the management unit DMS of the first application module AP, measurement data of individual measuring instruments M, for example, can be transmitted and processed in the management unit DMS. Measurement data from the management unit DMS, customer data from the customer unit CRM, and billing forms from the archive ARC can be assembled in the first application module AP, for example. This corresponds to component D*.

The measurement data, customer data, and billing forms from the first application module AP can be requested, for example by the module OSS/BSS of the second application module AP, processed into online bills, and sent to the end user U. This corresponds to component E*.

Upon request of the end user U to the user module VP of the second application module AP, data from, e.g., sensors of the measuring instruments M implemented as household appliances A can be transmitted to the end user U. The data of the sensors, which are acquired regularly and/or in real time, can be processed and made available by the server computing unit, queried and transmitted by the client computing unit C with the aid of the data module R upon request of the user module VP. The end user can thereby also control the actuators of his household appliances A. To control the actuators of the household appliances A, the end user U specifies, e.g., the desired position of the actuator. In the control module of the user module VP, this information is converted into data for controlling the corresponding actuator. Upon request of the control module, the client computing unit C forwards the data for controlling to the microserver of the server computing unit S, which handles the actuator of the household appliance A. This corresponds to component F*.

In an embodiment of the present invention, the microservers Sm, Si serve as measurement and control systems for the relatively small domestic area, i.e., a measurement station MS with measuring instruments M with different usage sensors (e.g., electricity, gas, water). They also serve as intermediaries in the near-field communication and handle data acquisition and management (data aggregation & repository) as server component of the entire system. These microservers Sm, Si are used as “intermedial Multi-Utility Servers—iMUS”.

An inverted client/server system based on VPN technology can be used, which is inverted for performance-oriented fulfillment of its measurement and control tasks, i.e., many servers are queried by one client. The measurement and control system can be used for automated measurement of meter data and also for reading any desired sensors and controlling any desired actuators in a connection and network technology based on the public Internet, i.e., it is used for reading and controlling an extremely wide variety of measuring instruments M.

The microservers Sm, Si installed at the consumer (user), i.e., in a measurement station MS, carry out the following processes:

1) Reading and, if applicable, reacting to the measuring instrument or instruments M connected, such as electric meters, and also “multi-utility metering,” i.e., reading and, if applicable, reacting to measuring instruments M of other types of energy and usage quantities (gas, heat, water), i.e, telemetry exclusively in the local area.

2) Converting the acquired data and making the acquired data available, i.e., converting the data from the diverse, sometimes proprietary, protocol world of measurement and control technology to the standard protocol world of the Internet; including, for example, as necessary network protocols:

ARP (Address Resolution Protocol), ETHER (Ethernet Frame Handling), PPP (Point-To-Point Protocol with LCP, CCP, PAP, CHAP), PPPoE (PPP over Ethernet), IPv4 (Internet Protocol with ICMP, IGMP and Multicast Support), ROUTE (IP Routing Module), SOCKETS (TCP—Transport Control Protocol & UDP—Universal Datagram Protocol), USERAUTH (User-Name/Password Authorization Handling) and also IPv6

and including, for example, as necessary application protocols:

FTPS (File Transfer Protocol Server), UPNP (Universal Plug & Play Device Service with SOAP/XML), SMTP (e-mail client), possibly POP3 (e-mail retrieval client), SOCK (Stream Socket Library), SNTP (Simple Network Time Protocol with SNMPTRAP), Syslog (System Logging over UDP), DHCP (Dynamic Host Configuration Protocol), RESOLVE (Domain Name Resolver), HTTPD (embedded Webserver/Hypertext Transport), possibly also NETCON (Telnet Console), PING (ICMP Echo Request Probe), SSDP (Simple Service Discovery Protocol).

3) Above and beyond the regular tasks of a protocol converter (“Protocol Converter,” “Gateway”), processing the data, for example, storing or evaluating in accordance with the rules defined in the server application (for example, setting up a daily cycle or load distribution).

4) Processing the data, such as temporal correction between data generation and data transport (also generation of fill-in values in the event of meter failure, if applicable).

5) Monitoring the entire measurement and control system located in the building (in the measurement station MS) for operational stability and security from tampering.

6) Encrypting the communication between measuring instruments, such as meters and microservers (if necessary) and between microservers Sm, Si and the client computing unit C during utilization of a VPN over the Internet, i.e., communications network N.

These server applications and network protocols are implemented on the microservers Sm, Si, i.e., on the so-called iMUS (intermedial Multi-Utility Servers).

The microserver(s) Sm, Si with a relatively small observation space for measuring the energy and supply data of a measurement station MS, i.e., in an apartment or in a single-family or multi-family house, could be queried with a standard browser as the client computing unit C, in which case access rights would still have to be considered separately for reasons of data protection and data security.

The client computing unit C, which, as the sole “trusted party” can query all microservers Sm, Si, carries out the following processes:

1) Managing a data module (repository R), which contains all device data (identifiers, parameters, localization (location and data address), access rights, . . . ) and measurement data;

2) Processing the data, such as decryption and inclusion of the measurement data (relevant to billing and/or informational) made available by the microservers Sm, Si in this repository R;

3) Forwarding the processed data to the authorized application modules AP, i.e., programs or institutions for invoicing, for processed presentation of the usage data to the users in a separate Web service, for higher-level statistical processing of energy and supply data, for device management of the measurement and control systems installed in the households and after installation of suitable sensors and actuators for applications in the “home care,” “facility management,” and if applicable “health care” areas, for example, for the purpose of “assisted living”;

4) Implementing a common time concept: the use of standardized Internet protocols and the extremely short transmission times, in the statistical average, even in a “best effort” VPN, which is loaded solely by the behavior of the client computing unit C and possible alarm messages from the microservers Sm, Si, ensures that the time that is known or to be made known to each of the servers and measuring devices, agrees with only small deviations. Each measurement can thus be provided with a time stamp that indicates a system time with an accuracy at least in the range of seconds.

With the aid of data records sent from the client computing unit C to application modules AP, for example, the application platform, it is not only possible to individually acquire data relevant for accounting for each usage to the energy producer/energy distributor and present variations in usage and base loads to the user in a plausible manner, but it is also possible to derive short-term and long-term predictions from different accumulations, prepare cumulative balance sheets and statistical analyses in the first place, and if applicable, also exercise performance-related and rate-related influence on devices.

The present invention permits, in an optimal manner, separate implementation of the roles of a metering point operator and metering service provider independent of an electricity generating company, such as is proposed for the future in the energy management law. The system is client-compatible in that, for example, by means of “white lists,” different accounting service providers or electricity generating companies can be provided sole and exclusive access to the metering points and measurement values of their customers.

A method according to the present invention and a corresponding distributed system makes it possible to perform energy and supply management.

The present invention permits automatic remote reading of measuring instruments M, such as house service meters (automated meter reading—AMR), for example, for tariff customers, by means of microservers Sm, Si. The microservers Sm, Si permit additional measurement and control tasks in the measurement stations MS in a relatively large area.

A key point is the use of an inverted client/server model. The use of microservers Sm, Si, which are built-in as small electronic components and carry the server programs, is of great advantage. The server programs of the microservers Sm, Si are driven by the authorized client program of the client computing unit C. The client program operates the data module R of the client station CS, which in this example is designed as a device and measurement data repository, and allows access only by authorized application modules AP (e.g., applications).

The definition of the corresponding tasks and technical requirements for the virtual private network VPN is accomplished by coordinating the client computing unit C and the server computing units SI.

The use of an inverted client/server model makes it possible to satisfy stringent requirements for data security and data integrity, allowing the overall system to obtain approvals for calibration and safety from the corresponding institutions. Through authentication of only one possible client C with a large number of microservers Sm, Si by means of secured exchange of “shared secrets” that are server-specific and thus user-specific as the basis of symmetric or asymmetric (public key at the server, private key at the metering service provider), a high level of security is achieved without great additional technical effort; the communication over a VPN encompassing all servers and one client as a “demilitarized zone” provides the integrity of the source and destination of the communication and prevents tampering even without additional investment and operating effort for “intrusion detection” and “firewall” systems.

The concept of a microserver Sm, Si designed as an intermedial multi-utility server at the location of the meter or measurements allows the connection of new meter types by solely incorporating a specific “driver” in this system. The service to be performed by the server—the “measurement”—can still be queried without distinction by the client, e.g., via HTTP requests. Only the metering point operator, and not the metering service provider, should know and take into account the specifics of the individual metering points. Thus, for this reason it is also possible to use a uniform, higher-level identifier, regardless of meter type or manufacturer-specific serial number. Within the scope of the present invention, IPv6 addresses (128-bit) can be used, which initially serve only as identifiers for all physical components, but can also be used as destination addresses for standardized Internet services upon switchover of the VPN and extension of home networks to Internet Protocol Version 6.

The ability to implement specific rules for storage of data in the microservers Sm, Si and the accuracy of the system time also permit the implementation of electric meters with the far lower level of complexity of, e.g., water or heat meters. Electricity usage and (daytime-dependent or producer-dependent) tariff need not be set in relation to one another in the meter, but instead can be set in relation to one another in a manner decoupled in time and location in special modules of the application platform. A simple electric meter to be developed in conjunction with the present invention represents a considerable cost savings for “energy and supply management” in the mass market.

The modular design of the overall system and the operational autonomy of the subsystems with standardized Internet protocols as interfaces permits not only cost reduction, but also far-reaching modularization of acquisition and management processes.

Measured data acquired at short time intervals represent a value in themselves when—as is made possible by the described present invention—they can be uniquely associated with a time, a physical location, a data address and a metering point and can be quickly queried. By means of appropriate Web portals fed by the client, the present invention allows energy producers, operators of accounting services, the housing industry, and municipal utilities, and not least energy advisors for users, to offer services economically over the Internet on the basis of these measurement data.

The present invention is not limited to embodiments described herein; reference should be had to the appended claims.

1-23. (canceled)

24. A method for acquiring and managing data from a plurality of measuring instruments, the method comprising:
acquiring data from at least one measuring instrument disposed in each of at least one measurement station;
providing the data to a server computing unit;
processing the data in the server computing unit with at least one microserver so as to provide client-compatible data;
accessing the client-compatible data in the server computing unit of the at least one measurement station through a communication network in at least one client station; and
further processing the accessed client-compatible data in the at least one client station with at least one client computing unit.

25. The method as recited in claim 24, wherein the at least one microserver is configured to control the at least one measuring instrument and any additional device(s).

26. The method as recited in claim 24, wherein the at least one measuring instrument is provided as a house service meter, and the providing and processing is performed by the at least one microserver.

27. The method as recited in claim 24, wherein the at least one measuring instrument is provided as at least one household appliance comprising at least one sensor, and the providing and processing is performed by the at least one microserver.

28. The method as recited in claim 27, further comprising transmitting a control data with the at least one microserver to the at least one measuring instrument provided as the at least one household appliance comprising an actuator, or to at least one additional device comprising the actuator.

29. The method as recited in claim 24, wherein the data acquired from the at least one measuring instrument are provided as an XML document in the server computing unit during the processing to the client-compatible data.

30. The method as recited in claim 24, further comprising encrypting the data acquired in the server computing unit and decrypting the data in the client computing unit.

31. The method as recited in claim 24, wherein the accessing of the client-compatible data from the server computing unit by the client computing unit is performed with a data module.

32. The method as recited in claim 24, wherein the accessing of the client-compatible data from the server computing unit by the client computing unit results from a query by at least one application module, and further comprising forwarding the data to the application module.

33. The method as recited in claim 32, wherein the accessing of the client-compatible data is performed by at least one end user through the at least one application module.

34. The method as recited in claim 32, further comprising forwarding data by the client computing unit to the server computing unit upon a query by the at least one application module comprising a control module.

35. The method as recited in claim 24, wherein a dynamically changing addressing is configured for the accessing of the client-compatible data from the server computing unit, wherein the dynamically changing addressing is performed through a DSL connection configured to use address management commands of a Session Initiation Protocol.

36. A distributed system for acquiring and managing data from a plurality of measuring instruments, the distributed system comprising:
two or more measurement stations, each of which includes at least one measuring instrument and a server computing unit comprising at least one microserver, the server computing unit being configured to provide the data as a client compatible data;
at least one client station comprising a client computing unit; and
a communication network,
wherein the client computing unit is configured to access the data made available by the server computing unit through the communication network.

37. The distributed system as recited in claim 36, wherein at least one of the at least one measuring instrument is provided as a house service meter connected to the at least one microserver.

38. The distributed system as recited in claim 36, wherein at least one of the at least one measuring instrument is provided as a household appliance comprising at least one sensor connected to the at least one microserver.

39. The distributed system as recited in claim 38, wherein the at least one measuring instrument is provided as a household appliance comprising at least one actuator, the measuring instrument being connected to the at least one microserver, or as an additional device comprising at least one actuator, the additional device being connected to the at least one microserver.

40. The distributed system as recited in claim 36, wherein the client computing unit is associated with a data module.

41. The distributed system as recited claim 36, wherein the client computing unit is connected to at least one application module.

42. The distributed system as recited in claim 41, wherein the at least one application module is configured to be queried by at least one end user.

43. The distributed system as recited in claim 41, wherein the at least one application module comprises at least one control module.

44. The distributed system as recited in claim 36, wherein the server computing unit is connected to the communication network through a DSL connection configured to use address management commands of a Session Initiation Protocol.

45. Process of using a distributed system for acquiring and managing data from a plurality of measuring instruments, the process comprising:
providing a distributed system comprising:
at least one measurement station, each of which includes at least one measuring instrument and a server computing unit comprising at least one microserver, the server computing unit being configured to provide the data as a client compatible data,
at least one client station comprising a client computing unit, and
a communication network, wherein the client computing unit is configured to access the data made available by the server computing unit through the communication network;
acquiring the data from the at the least one measuring instrument;
providing the data to the server computing unit;
processing the data in the server computing unit with the at least one micro server so as to provide client-compatible data;
accessing the client-compatible data in the server computing unit of the at least one measurement station through the communication network by at least one client station; and
further processing the accessed client-compatible data in the at least one client station with the at least one client computing unit.
